(19) United States
(12) Patent Application Publication
(10) Pub. No.: US 2010/0306209 A1
(43) Pub. Date: Dec. 2, 2010

(54) PATTERN MATCHER AND ITS MATCHING METHOD

(75) Inventors: Tien-Fu Chen, Chia-Yi (TW); Chieh-Jen Cheng, Chia-Yi (TW)

Correspondence Address: BRIAN M. MCINNIS, 12th Floor, Ruttonjee House, 11 Duddell Street, Hong Kong, HK

(73) Assignee: Tien-Fu Chen, Chia-Yi (TW)

(21) Appl. No.: 12/855,709

(22) Filed: Aug. 13, 2010

Related U.S. Application Data
(63) Continuation-in-part of application No. 11/459,349, filed on Jul. 22, 2006, now abandoned.

(51) Int. Cl. G06F 17/30

(52) U.S. Cl. 707/758; 707/E17.039

(57) ABSTRACT

A pattern matching method is disclosed. The method includes following steps. A character is searched in a skip table of a pattern such that a flag value and a skip value are returned. The sliding window is shifted according to the skip value when the flag value indicates the character is not a pattern end. The character plus at least one byte preceding the character is hashed when the flag value indicates the character is the pattern end such that a character hashing value is returned. A pattern end portion is hashed, wherein the size of the pattern end portion is equal to the size of the character plus the size of the byte such that a pattern hashing value is returned. The character hashing value is compared with the pattern hashing value. An exact matching process is performed when the character hashing value is equal to the pattern hashing value.

### RELATED APPLICATIONS

The application is a continuation-in-part of U.S. patent application Ser. No. 11/459,349 filed Jul. 22, 2006, the disclosure of which is hereby incorporated by reference as if fully set forth herein

### BACKGROUND

1. Technical Field

The present disclosure relates to a matching system. More particularly, the present disclosure relates to a pattern matcher and its matching method.

2. Description of Related Art

A pattern matching is the core of a network intrusion detection system, and nowadays the network intrusion detection system builds the pattern database to store existing patterns. The network intrusion detection system compares strings of the attacking packets with the existing patterns from the pattern database to determine whether the strings contain the pattern. However, network intrusion detection systems spend a considerable amount of time examining every packet with the patterns stored in the pattern database. Therefore a software algorithm and a hardware method are adopted in order to speed up the pattern matching process.

There are generally two types of pattern matching software algorithms that speed up the pattern matching process. The first type, the Finite State Machine (FSM), uses a character as an input unit and requires building a state table containing the possible status of the next character, which uses considerable quantities of memory. The second type is to build a shift table that only contains the shift values to skip through the string if does not contain the pattern. However, if the pattern database contains more than 10,000 patterns then the full pattern matching rate increases significantly.

The pattern matching hardware method can be divided into:

(1) A comparator uses the Filed Programmable Gate Array (FPGA) to provide a renewable pattern environment. The comparator FPGA can handle the information at the rate of 2 gigabits/second. However, the comparator use of the FPGA is restricted due to the capacity of the FPGA and nowadays the FPGA cannot handle all the existing patterns;

(2) A Finite State Machine (FSM) with an Application Specific Integrated Circuit (ASIC) is built. Determination of the next state requires a higher bandwidth to read from a state table. Nowadays, the memory and the FSM are designed on the same chip and use an on-chip bus to provide the required memory bandwidth. However, the forgoing method restricts the capacity of the memory and cannot support the ever increasing number of patterns; and

(3) Content Addressable Memory (CAM) has the advantage of comparing the string with all the patterns in the memory simultaneously. However, the drawback of using CAM is low memory capacity for storing the patterns, higher power consumption and low execution speed.

The software uses an algorithm to provide low complexity and can be executed in the General Purpose Processor (GPP). However, the GPP cannot satisfy network intrusion detection system requirements in super high-speed networks. The hardware pattern matching method cannot handle all the existing patterns, requires higher memory bandwidth, higher cost and higher power consumption. Hence the practical use of the hardware pattern matching method is reduced.

For the forgoing reasons, there is a need to improve the pattern matcher skip structure to provide support for handling all the existing patterns using the preprocessing method in order to reduce the full pattern matching rate.

### SUMMARY

According to one embodiment of the present disclosure, a pattern matching method includes the following steps. A character is searched in a skip table of a first pattern such that a flag value and a skip value are returned, wherein the character is sampled from a string by a sliding window. The sliding window is shifted according to the skip value when the flag value indicates the character is not a pattern end. The character plus at least one byte preceding the character is hashed when the flag value indicates the character is the pattern end such that a character hashing value is returned. A pattern end portion is hashed, wherein the size of the pattern end portion is equal to the size of the character plus the size of the byte such that a pattern hashing value is returned. The character hashing value is compared with the pattern hashing value. An exact matching process is performed when the pattern hashing value matches the character hashing value.

According to another embodiment of the present disclosure, a computer-readable medium has computer-executable instructions for performing a method including the following steps. A character is searched in a skip table of a first pattern such that a flag value and a skip value are returned, wherein the character is sampled from a string by a sliding window. The sliding window is shifted according to the skip value when the flag value indicates the character is not a pattern end. The character plus at least one byte preceding the character is hashed when the flag value indicates the character is the pattern end such that a character hashing value is returned. A pattern end portion is hashed, wherein the size of the pattern end portion is equal to the size of the character plus the size of the byte such that a pattern hashing value is returned. The character hashing value is compared with the pattern hashing value. An exact matching process is performed when the pattern hashing value matches the character hashing value.

### BRIEF DESCRIPTION OF THE DRAWINGS

FIG. 1 illustrates a skip table of a pattern matching method according to one embodiment of the present invention.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawings.

The pattern matching method includes following steps. A character is searched in a skip table of a first pattern such that a flag value and a skip value are returned, wherein the character is sampled from a string by a sliding window. The sliding window is shifted according to the skip value when the flag value indicates the character is not a pattern end. The character plus at least one byte preceding the character is hashed when the flag value indicates the character is the pattern end such that a character hashing value is returned. A pattern end portion is hashed, wherein the size of the pattern end portion is equal to the size of the character plus the size of the byte such that a pattern hashing value is returned. The character hashing value is compared with the pattern hashing value. An exact matching process is performed when the pattern hashing value matches the character hashing value.

The process that character is sampled from a string by a sliding window is performed by a string pump, and then the character is stored in a string buffer. The method said before is performed by a filtering engine except for sampling the character from a string. The skip table is stored in an on-chip memory of the filtering engine. The sliding window is shifted by a prefix address controller of the filtering engine.

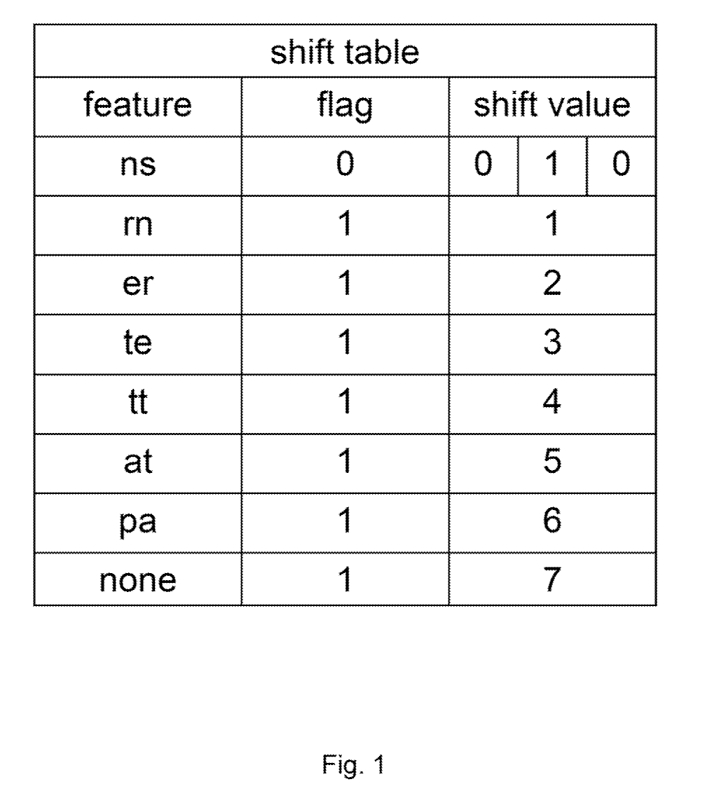

FIG. 1 illustrates a skip table of a pattern matching method according to one embodiment of the present invention. The skip table stores three data, which are features, skip values, and flags. The features are sampled from the first pattern. The difference between two adjacent features is one byte. The size of the features and the sliding window are the same. The pattern end portion is constituted by the pattern end plus at least one byte preceding the pattern end.

For instance, the first pattern is defined as “patterns”. The size of the sliding window and the features are two bytes. The features are defined as “pa”, “at”, “tt”, “te”, “er”, “rn”, and “ns”. The feature “ns” is the pattern end. The flag indicated the pattern end “ns” is defined as “0”, and the other flag are defined as “1”. The skip values relative to the features which are not the pattern end are “6”, “5”, “4”, “3”, “2”, and “1”. Moreover, the skip value is defined as “7” when the character within the sliding window does not correspond to anyone feature. The pattern end portion is defined as “erns”, which is constituted by the pattern end “ns” plus two bytes “er” preceding the pattern end. The pattern end portion is hashed, and a pattern hashing value is returned. The pattern hashing value is defined as “0011”, wherein the pattern hashing value is stored as binary numeral system. The pattern hashing value is defined as the skip value of the feature “ns” in the skip table.

In detail, the number of the bits of the pattern hashing value is the same as the number of the bytes of the pattern end portion, and each pattern hashing value only has one bit “1”. For example, the pattern end portion has four bytes is “e”, “r”, “n”, and “s”, and the pattern hashing value has four bits. The pattern hashing value may be defined as “1000”, “0100”, “0010”, or “0001”. The pattern hashing values are usually different when the pattern end portions are different. The pattern hashing value is defined as “0001” in the embodiment.

The character is sampled from the start of the string by the sliding window. For instance, the string is defined as “rnabcdpatternsgh”. Performing the method, the character “m” within the sliding window is searched first. The flag “1” and skip value “1” are returned when the character “rn” corresponds to the feature “rn” in the skip table. The sliding window shifts 1 byte rightward to search next character “na”. The flag “1” and skip value “7” are returned when the character “na” does not correspond to any feature. The sliding window shifts 7 bytes rightward to search next character “tt”. The flag “1” and skip value “4” are returned when the character “tt” corresponds to the feature “tt”. The sliding window shifts 4 bytes rightward to search next character “ns”. The skip value “0” is returned when the character “ns” corresponds to the feature “ns”.

Furthermore, the character “ns” plus two bytes “er” preceding the character is hashed, and a character hashing value is returned. The character hashing value is stored as binary numeral system; and only one bit of the character hashing value is “1”. For example, the character includes four bytes, and the character hashing value has four bits. The character hashing value may be defined as “1000”, “0100”, “0010”, or “0001”. The character hashing value is defined as “0001” in the embodiment. Therefore, the exact matching process is performed when the pattern hashing value “0001” matches the character hashing value “0001”.

The pattern hashing value matching the character hashing value said before means that the pattern hashing value is the same as the character hashing value, or the pattern hashing value includes the character hashing value.

About the pattern hashing value the same as the character hashing value, the pattern end portion is usually the same as the character when the two hashing value are the same. However, sometimes different pattern end portions may have the same pattern hashing value, and the exact matching process will check the pattern end portion and the character.

About the pattern hashing value including the character hashing value, it happens when there are at least two patterns, and the patterns have the same pattern end. The pattern hashing values of the patterns are usually different, and the pattern hashing values add together. For example, there are two different patterns, and the two different pattern hashing values are defined as “0001” and “0010”. The total pattern hashing value by adding the two pattern hashing values together is defined as “0011”. The bit “1” in the fourth position of the character hashing value is in the same position of the total pattern hashing value. Therefore, the character hashing value “0001” is included in the total pattern hashing value “0011”. For another example, there are two different patterns, and the two pattern hashing values are the same and defined as “0001”. The total pattern hashing value by adding the two pattern hashing values together is defined as “0001”. Therefore, the character hashing value “0001” is the same as the total pattern hashing value “0001”.

The exact matching process includes following steps. The string is separated into a plurality of string sections. The first pattern is separated into a plurality first pattern sections. The string section and the respective first pattern section are compared. In detail, the string sections are compared from the start.

Performing the method, for instance, the first pattern and the string are separated into two sections. The size of each section is 4 bytes. The first pattern has two first pattern sections “patt” and “erns”. The string has two string section “patt” and “erns”. The string section “patt” is compared with the first pattern section “patt”. The string section “erns” is compared with the first pattern section “erns”, when the string section “patt” corresponds to the first pattern section “patt”. Finally, a part of the string is exactly matched with the first pattern if all string sections correspond to all first pattern sections. Furthermore, the string sections are skipped if at least one of the string sections does not correspond to the respective first pattern section.

Furthermore, the exact matching process includes following steps, when there is a second pattern. The second pattern is separated into a plurality of second pattern sections. Each second pattern section is compared with all of the first pattern sections, and all of the second pattern sections are different from the first pattern sections. The second pattern sections are compared with the string sections, wherein the string section the same as one of the first pattern sections is skipped the comparison with the second pattern sections.

Performing the method, for instance, the second pattern is defined as “pataerna”, and the second pattern is separated into “pata” and “erna” two second pattern sections. As said before, the string section “patt” is the same as the first pattern section “patt”, so the string section “patt” is skipped to compare with the second pattern sections. Furthermore, the second pattern sections are skipped the comparison with the string sections when the string sections are the same as the first pattern sections.

Moreover, the exact matching process includes following steps, when the beginning second pattern section is the same as one of the first pattern sections defined as matched first pattern section. One of the string sections is skipped the comparison with the second pattern sections when the string section is the same as the matched first pattern section. The other string sections are compared with the second pattern sections.

Performing the method, for instance, the second pattern is defined as “patterna”. The second pattern is separated into “patt” and “erna” two second pattern sections. The first pattern section “patt” is defined as matched first pattern section. The beginning second pattern section “patt” is the same as the matched first pattern section “patt”. As said before, the string section “patt” is the same as the matched first pattern section “patt”, so the string section “patt” is skipped the comparison with the second pattern sections. After that, the string section “erns” is compared with the second pattern sections.

The process that the second pattern is separated into a plurality of second pattern sections, each second pattern section is compared with all of the first pattern sections, and the second pattern sections are compared with the string sections, are performed by an exactly-matching engine. The exactly-matching engine includes a prefix node buffer for storing the message about the beginning second pattern section the same as the matched first pattern section. The process that string section is skipped the comparison with the second pattern sections is performed by a trie skip mechanism.

A computer readable medium has computer-executable instructions for performing the method said before.

The reader's attention is directed to all papers and documents which are filed concurrently with his specification and which are open to public inspection with this specification, and the contents of all such papers and documents are incorporated herein by reference.

All the features disclosed in this specification (including any accompanying claims, abstract, and drawings) may be replaced by alternative features serving the same, equivalent or similar purpose, unless expressly stated otherwise. Thus, unless expressly stated otherwise, each feature disclosed is one example only of a generic series of equivalent or similar features.

Any element in a claim that does not explicitly state “means for” performing a specified function, or “step for” performing a specific function, is not to be interpreted as a “means” or “step” clause as specified in 35 U.S.C. §112, 6th paragraph. In particular, the use of “step of” in the claims is not intended to invoke the provisions of 35 U.S.C. §112, 6th paragraph.

What is claimed is:

1. A pattern matching method comprising:
searching a character in a skip table of a first pattern such that a flag value and a skip value are returned, wherein the character is sampled from a string by a sliding window;
shifting the sliding window according to the skip value when the flag value indicates the character is not a pattern end;
hashing the character plus at least one byte preceding the character when the flag value indicates the character is the pattern end such that a character hashing value is returned;
hashing a pattern end portion, wherein the size of the pattern end portion is equal to the size of the character plus the size of the byte such that a pattern hashing value is returned;
comparing the character hashing value with the pattern hashing value; and
performing an exact matching process when the pattern hashing value matches the character hashing value.

2. The pattern matching method of claim 1, wherein the character is sampled from the start of the string by the sliding window.

3. The pattern matching method of claim 1, wherein the exact matching process comprising:
separating the string into a plurality of string sections;
separating the first pattern into a plurality of first pattern sections; and
comparing each string section with the respective first pattern section.

4. The pattern matching method of claim 3, wherein the string sections are compared with the respective first pattern sections from the start of the string.

5. The pattern matching method of claim 3, wherein the exact matching process comprising:
separating a second pattern into a plurality of second pattern sections;
comparing each second pattern section with all of the first pattern sections, wherein all of the second pattern sections are different from the first pattern sections; and
comparing the second pattern sections with the string sections, wherein the string section the same as one of the first pattern sections is skipped the comparison with the second pattern sections.

6. The pattern matching method of claim 3, wherein the exact matching process comprising:
separating a second pattern into a plurality of second pattern sections;
skipping the comparison between one of the string sections and the second pattern sections, when the beginning second pattern section is the same as one of the first pattern sections defined as matched first pattern section, and the string section is the same as the matched first pattern section; and
comparing the other string sections with the second pattern sections.

7. A computer-readable medium having computer-executable instructions for performing a method comprising:
searching a character within a sliding window in a skip table of a first pattern such that a flag value and a skip value are returned, wherein the character is sampled from a string;
shifting the sliding window according to the skip value when the flag value indicates the character is not a pattern end;
hashing the character plus at least one byte preceding the character when the flag value indicates the character is the pattern end;
hashing a pattern end portion, wherein the size of the pattern end portion is equal to the size of the character plus the size of the byte;
returning a character hashing value;
returning a pattern hashing value;
comparing the character hashing value with the pattern hashing value; and
performing an exact matching process when the pattern hashing value matches the character hashing value.

8. The computer-readable medium of claim 7, wherein the character is sampled from the start of the string by the sliding window.

9. The computer-readable medium of claim 7, wherein the exact matching process comprising:
separating the string into a plurality of string sections;
separating the first pattern into a plurality of first pattern sections; and
comparing each string section with the respective first pattern section.

10. The computer-readable medium of claim 9, wherein the string sections are compared with the respective first pattern sections from the start of the string.

11. The computer-readable medium of claim 9, wherein the exact matching process comprising:
separating a second pattern into a plurality of second pattern sections;
comparing each second pattern section with all of the first pattern sections, wherein all of the second pattern sections are different from the first pattern sections; and
comparing the second pattern sections with the string sections, wherein the string section the same as one of the first pattern sections is skipped the comparison with the second pattern sections.

12. The computer-readable medium of claim 9, wherein the exact matching process comprising:
separating a second pattern into a plurality of second pattern sections;
skipping the comparison between one of the string sections and the second pattern sections, when the beginning second pattern section is the same as one of the first pattern sections defined as matched first pattern section, and the string section is the same as the matched first pattern section; and
comparing the other string sections with the second pattern sections.

13. A pattern matcher comprising:
means for searching a character in a skip table of a first pattern such that a flag value and a skip value are returned, wherein the character is sampled from a string by a sliding window;
means for shifting the sliding window according to the skip value when the flag value indicates the character is not a pattern end;
means for hashing the character plus at least one byte preceding the to character when the flag value indicates the character is the pattern end such that a character hashing value is returned;
means for hashing a pattern end portion, wherein the size of the pattern end portion is equal to the size of the character plus the size of the byte such that a pattern hashing value is returned;
means for comparing the character hashing value with the pattern hashing value; and
means for performing an exact matching process when the pattern hashing value matches the character hashing value.

14. The pattern matcher of claim 13, wherein the character is sampled from the start of the string by the sliding window.

15. The pattern matcher of claim 13, wherein the exact matching process comprising:
means for separating the string into a plurality of string sections;
means for separating the first pattern into a plurality of first pattern sections; and
means for comparing each string section with the respective first pattern section.

16. The pattern matcher of claim 15, wherein the string sections are compared with the respective first pattern sections from the start of the string.

17. The pattern matcher of claim 15, wherein the exact matching process comprising:
means for separating a second pattern into a plurality of second pattern sections;
means for comparing each second pattern section with all of the first pattern sections, wherein all of the second pattern sections are different from the first pattern sections; and
means for comparing the second pattern sections with the string sections, wherein the string section the same as one of the first pattern sections is skipped the comparison with the second pattern sections.

18. The pattern matcher of claim 15, wherein the exact matching process comprising:
means for separating a second pattern into a plurality of second pattern sections;
means for skipping the comparison between one of the string sections and the second pattern sections, when the beginning second pattern section is the same as one of the first pattern sections defined as matched first pattern section, and the string section is the same as the matched first pattern section; and
means for comparing the other string sections with the second pattern sections.
